(19) United States
(12) Patent Application Publication
(10) Pub. No.: US 2008/0124679 A1
(43) Pub. Date: May 29, 2008

(54) Method of Adapting a Dental Prosthetic Item Existing as a 3D Data Set

(76) Inventors: Ulrich Orth, Heppenheim (DE); Volker Wedler, Hirschberg (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/885,629

(22) PCT Filed: Mar. 1, 2006
(86) PCT No.: PCT/EP06/60350

§ 371 Date: Sep. 4, 2007

(30) Foreign Application Priority Data
Mar. 1, 2005 (DE) 10 2005 009 873.8

(51) Int. Cl. A61C 13/38

(52) U.S. Cl. 433/202.1

(57) ABSTRACT

The invention relates to a method for adjusting a digital dental prosthesis (5) that is provided as a 3D data record and has been created based on a 3D data record of a preparation zone (1) which encompasses the actual preparation point (2) and at least one adjacent tooth (3, 4) thereto. In order to adjust the approximal contact between the dental prosthesis (5) and the adjacent tooth (3), a contact area (8) is defined on the adjacent tooth (3), and the dental prosthesis (5) is automatically adjusted to said contact area.

### FIELD OF THE INVENTION

The invention relates to a method for adapting a dental prosthetic item existing as a 3D data set, particularly for configuring approximal contacts, in a dental CAD system.

### PRIOR ART

In dental CAD/CAM systems, automatic adaptation of the approximal contacts of a restorative proposal for a dental prosthetic item has hitherto been accomplished with the possibility of later manual adjustment by the user. However, in such cases the software used is unable to specify the position, size, and width of the approximal contact.

The restorative proposal in this case exists as a 3D data set of the dental prosthetic item to be produced and is therefore also referred to below as the dental prosthetic item itself or as the digital dental prosthetic item.

The present invention is intended to enable the user to construct or design approximal contacts on a dental prosthetic item according to his liking when using the design software.

### SUMMARY OF THE INVENTION

The method according to the invention serves to adapt a digital dental prosthetic item existing as a 3D data set produced on the basis of a 3D data set of a preparation zone, where the preparation zone includes the preparation site itself as well as at least one neighboring tooth.

To adapt the approximal contact between the dental prosthetic items and the neighboring tooth, a contact area is defined on the neighboring tooth, and the dental prosthetic item is automatically adapted to fit said contact area.

An automatic adaptation exists if on the basis of pre-defined parameters the position of the contact area on the neighboring tooth is determined and no further operations are necessary.

The basic concept of the invention is to establish the visual aspect, variability and adaptability of the approximal contact. The position of the contact in this case may be defined by the user or be proposed automatically or both.

According to an advantageous development, the position of the contact area is specified by selecting a point on the neighboring tooth, and variable parameters defining the extent of the contact area around the selected point determine the size of the contact area.

The contact area is advantageously in the form of an elliptical zone.

According to an advantageous development, a parameter defining the spacing between the deformed dental prosthetic item and the neighboring tooth in the contact area is variable. This has the advantage that individual adaptation is possible and that, depending on the situation in the preparation zone, protrusion, abutment, or a gap may be adjustable.

Advantageously, in order to adapt the dental prosthetic item to fit the contact area, the dental prosthetic item is first deformed, in which case the dental prosthetic item is deformed so as to extend toward the contact area, preferably its center, until the deformed dental prosthetic item is at least at the required distance from the neighboring tooth along the entire boundary of the contact area. This ensures that the desired spacing can be produced for the entire contact area so that the size of the contact area is preserved.

It is also advantageous if the dental prosthetic item is further deformed within the boundary of the contact area until the deformed dental prosthetic item is at the required distance from the neighboring tooth over the entire contact area. For this purpose, the surface of the contact area is subjected, to the same extent, to reverse deformation with respect to the deformation direction used in the first step, which, however, is not to be understood in the strictly mathematical sense as regards direction.

It is also advantageous if there is smoothing of the transition region between the contact area of the dental prosthetic item and the surrounding region.

In order to facilitate work, it is advantageous if the contact area of the neighboring tooth is obtained on the basis of a model of the neighboring tooth stored in a tooth database, in which case the model of the neighboring tooth will display a pre-defined contact area.

For better control and ease of selection it is advantageous if the contact area selected is marked in an optically perceptible manner. Such marking is very suitably in the form of coloration of the surface.

In order to be able to change its position and size, it is advantageous if the contact area selected is variable, i.e. capable of being moved along the surface of the neighboring tooth and of being re-sized.

Instead of selecting a point and employing automatic determination of the contact area by the software, it may be advantageous if the contact area is drawn in by the user. In this way, any desired geometries of the contact area can be realized.

### BRIEF DESCRIPTION OF THE DRAWINGS

An exemplary embodiment of the invention is shown in the drawings, in which:

FIG. 1 shows a digital data set of a preparation zone,

FIG. 2A shows the situation of FIG. 1 with a restorative proposal for a dental prosthetic item,

FIG. 2B is a diagram showing the required deformation on the dental prosthetic item,

FIG. 2C is another diagram indicating the required deformation produced from a direction other than that that used in FIG. 2B,

FIG. 3 shows the situation of FIG. 2 with a restorative proposal suitably adapted to fit the neighboring teeth,

FIG. 4A shows an neighboring tooth comprising a contact area,

FIG. 4B is a diagrammatic representation of the contact area,

FIGS. 5A-5C show a first case in which the distance d from the neighboring tooth is greater than zero,

FIGS. 6A-6C show a second case in which the distance d from the neighboring tooth is equal to zero,

FIGS. 7A-7C show a third case in which the distance d from the neighboring tooth is less than zero.

### DESCRIPTION OF AN EMBODIMENT

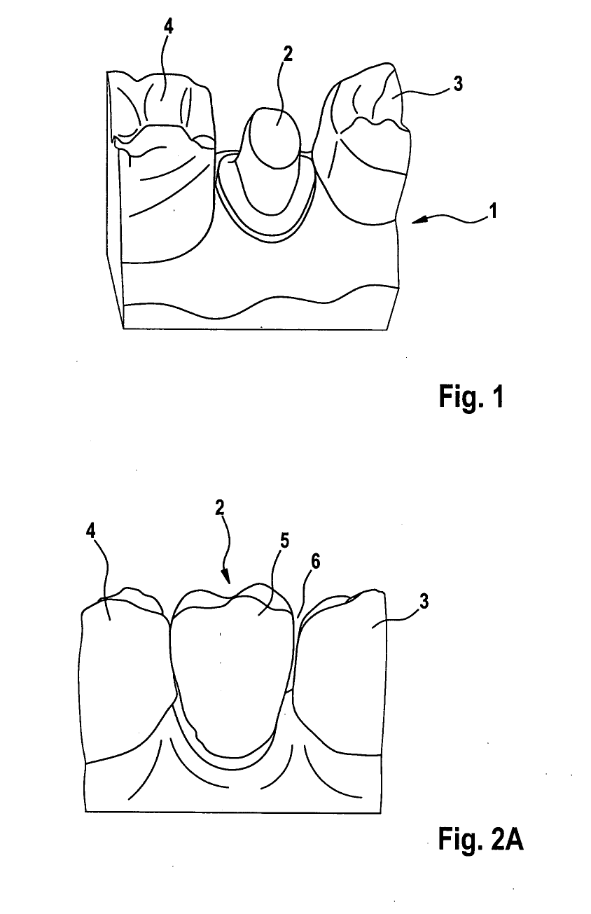

FIG. 1 shows a digital data set of a preparation zone 1 that can be obtained by 3D scanning. The preparation zone includes the actual preparation site 2 as well as a first neighboring tooth 3 and a second neighboring tooth 4.

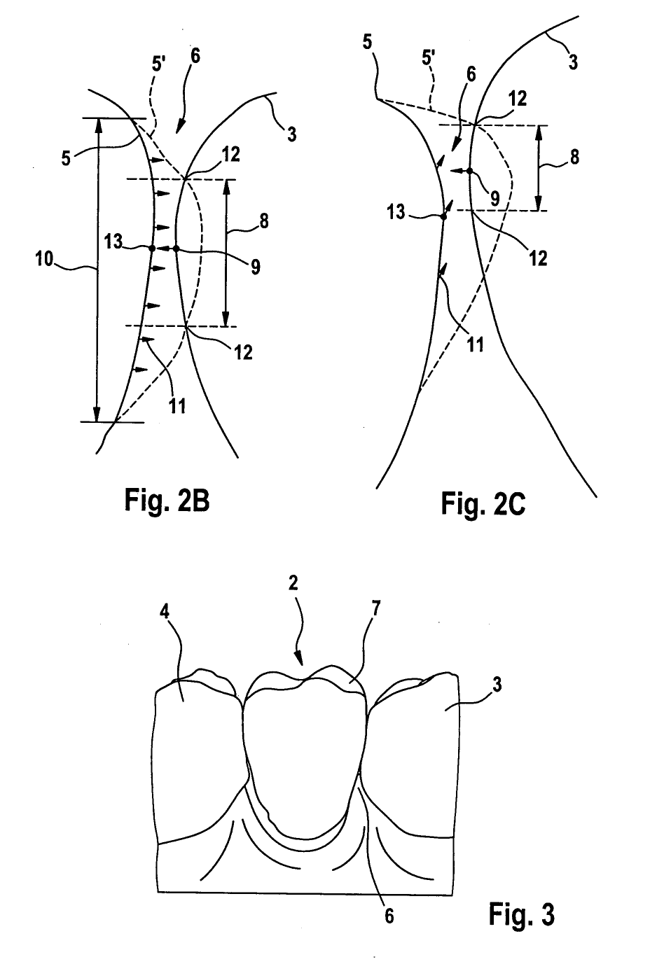

FIG. 2a shows the situation of FIG. 1 with a restorative proposal for a dental prosthetic item 5 on the preparation site 2. The restorative proposal for the dental prosthetic item 5 was calculated on the basis of the rules of design, and it can be seen that a gap 6 is present between the restorative proposal of the dental prosthetic item 5 and the neighboring tooth 3—see also the diagrams in FIGS. 2B and 2C, which will be explained in more detail below.

In FIG. 3 the situation of FIG. 2a is shown with a dental prosthetic item 7 suitably adapted to the neighboring teeth, the contour of the gap 6 having been altered.

For correct configuration of the desired dental prosthetic item it is essential that the contact with the neighboring teeth, also referred to as the approximal contact, is adequately established in the right place, as merely a point of contact will not achieve satisfactory results.

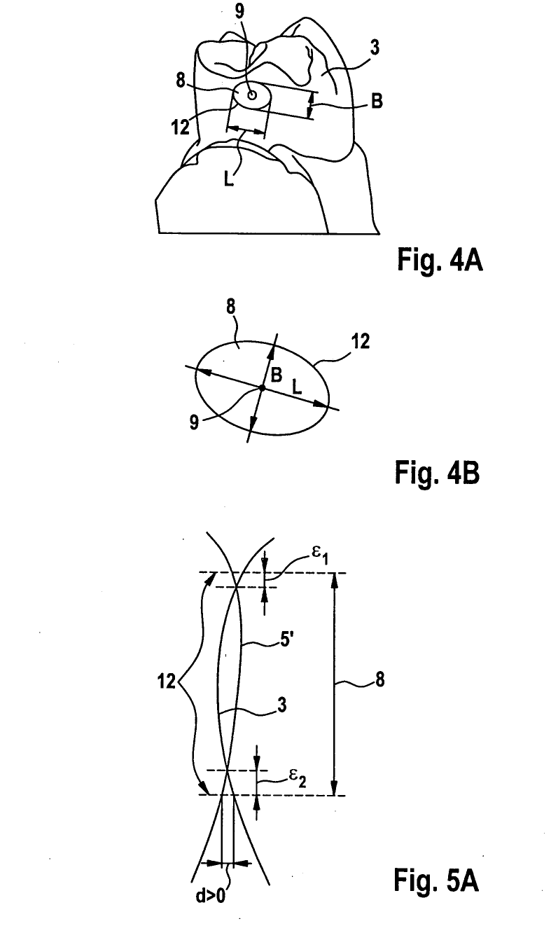

In FIG. 4a, therefore, the neighboring tooth 3 is shown with a contact area 8 and a center point 9 of said contact area 8.

In the method of the invention, therefore, first a contact area 8 on the neighboring tooth 3 is selected. To this end the user marks, for example, the center point 9 of the contact area 8. The contact area 8 covers an area over part of the surface of the neighboring tooth 3.

The size of the area covered can be adjusted by the user by means of appropriate parameters—see the diagram in FIG. 4b. The contact area 8 is in this case indicated as an ellipse, and the user can change the size of the ellipse by changing the primary and secondary axes L, B. In order to change the position of the contact area on the neighboring tooth 3, the center point 9 of the contact area 8 can be moved on the surface of the neighboring tooth, e.g., by mouse-dragging the area 8.

The dental prosthetic item 5 is then deformed toward the contact area 8 of the neighboring tooth 3 in accordance with a pre-defined parameter determining the distance d, which is adjustable by the user—see the representation in FIG. 2b, in which the deformation of the dental prosthetic item 5′ is indicated by a dashed line.

In a first step, for this purpose, the dental prosthetic item 5 is deformed in a region 10 in the direction 11 toward the contact area 8 until the desired distance from the boundary 12 of the contact area 8 is reached. On completion of this step, the surface 10 of the deformed dental prosthetic item 5′ usually protrudes into at least part of the outer contour of the neighboring tooth.

The dental prosthetic item 5 is therefore deformed in the direction of the contact area 8, preferably its center 9, until the deformed dental prosthetic item 5′ is at least at the required distance from the neighboring tooth 3 over the entire boundary 12 of the contact area. In this case the deformation covers a large area and extends outwardly.

The contact area 8 on the neighboring tooth is usually selected by the user in such a way that the center point 9 of the marked contact area 8 approximately coincides with a contact point 13 opposite to one present in the restorative proposal, which has already been used for generation of the restorative proposal and the position of which is therefore known. This contact point 13 in the surface region 10 of the dental prosthetic item 5 to be deformed can be marked in FIG. 2a in order to assist in selecting the contact area on the neighboring tooth. Also, in the representation of the neighboring tooth in FIG. 4a, the contact point of the restorative proposal for the dental prosthetic item 5 can be projected in order to facilitate positioning of the contact area 8 on the neighboring tooth.

Instead of effecting deformation of the dental prosthetic item 5 by starting from the known contact point 13 on the dental prosthetic item 5 and moving toward the center point 9, a different deformation direction may be chosen, for example deformation in the opposite direction along the normal to the center point 9, as represented by an arrow. This is advisable when the contact point of the dental prosthetic item 5 is strongly offset from the contact area on the neighboring tooth.

FIG. 2C is another diagram showing the required amount of deformation of the dental prosthetic item 5 from a different direction from that shown in FIG. 2B, i.e., from a direction 11 starting from below the center point 9 of the contact area 8 on the neighboring tooth 3. The resulting contour of the dental prosthetic item 5′ protrudes into the neighboring tooth 3 but still has at least the pre-defined distance from the boundary 12 of the contact area. The gap 6 is partially filled at this time.

In a second step, the surface of the dental prosthetic item 5′ is deformed within the contact area 8 over its entire surface such that the desired distance d is established at least over the entire contact area 8. As a rule, this results in a deformation direction which is the reverse of the direction in the first step.

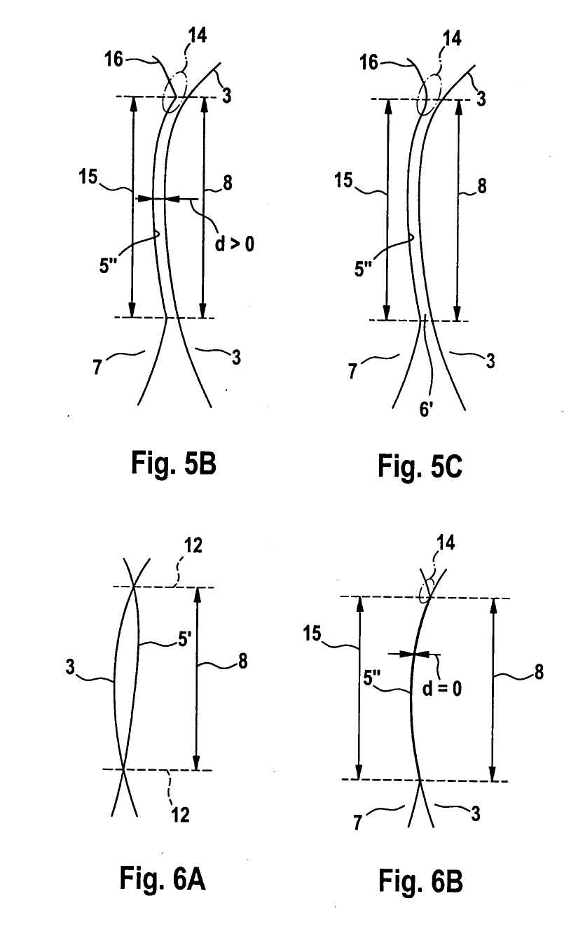

In a third step, the transition region 14 (FIGS. 5-7) between the contact area 15 formed on the dental prosthetic item and the surface of the dental prosthetic item 7 surrounding the contact area 15 is smoothed.

As regards the distance d, three cases are to be distinguished, which will be explained in more detail below in FIGS. 5 through 7. In each case, there is shown a cross-section in the region of the contact area 8 through a prosthetic item in the form of a crown and through the neighboring tooth 3.

In the first case shown in FIG. 5, the dental prosthetic item 7 is required to be at a distance d from the neighboring teeth that is greater than zero. This finally forms a gap between the dental prosthetic item 7 and the neighboring tooth 3.

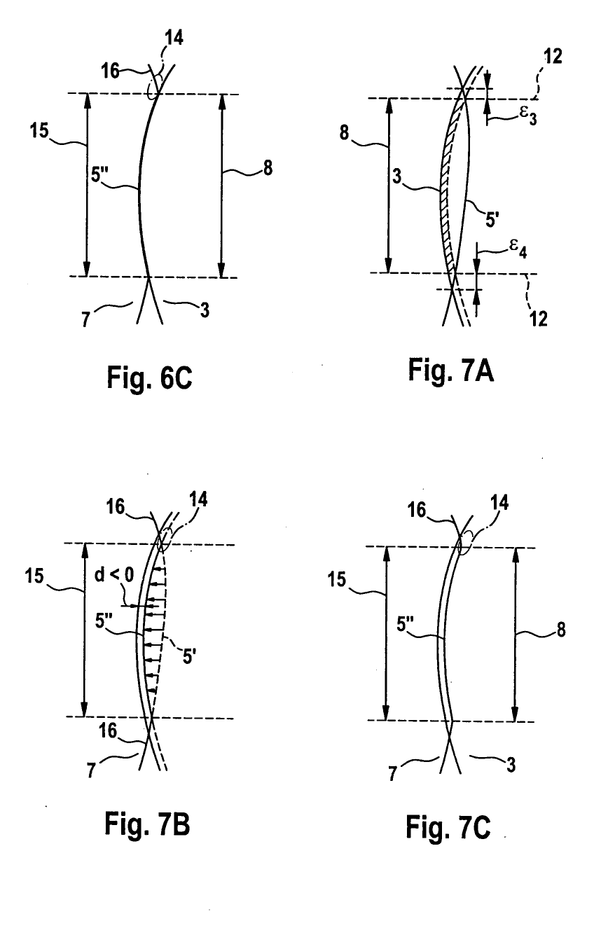

In the second case shown in FIG. 6, the dental prosthetic item 7 is required to abut the selected contact area 8 of the neighboring tooth 3 with no gap therebetween. The distance d is therefore zero.

In the third case shown in FIG. 7, the dental prosthetic item 7 is required to be oversized so that, in the CAD design, the dental prosthetic item 7 will partially protrude into the neighboring tooth 3. The distance d here is therefore less than zero. This may be desirable when the dentist wants to guarantee good contact and accordingly manually imparts the final shape to the dental prosthetic item produced according to the restorative proposal.

The individual cases of FIGS. 5 through 7 will now be described in more detail. In FIGS. 5A-7A, the situation in the contact area after the first step, that is, after the first deformation of the restorative proposal for the dental prosthetic item, is shown in each case. At the boundary 12 of the contact area 8, represented by dashed lines, the pre-defined distance d is established with execution of the first step. It is essential that at least the selected contact area 8 is at this distance, but it does not matter if the contact area actually created becomes greater than the selected contact area 8.

In the first case, shown in FIG. 5A, the dental prosthetic item 5′ protrudes into the neighboring tooth 3 only over part of the contact area 8 and maintains the pre-defined distance d at the boundary 12. This protruded region is smaller than the contact area 8 by the distances ε₁, ε₂ from the boundary 12.

In the second case shown in FIG. 6A, protrusion or contact at the boundary 12 is established over the entire contact area 8.

In the third case shown in FIG. 7A, minimal protrusion of width d is established over the entire contact area 8 including the boundary 12, in which case d is less than zero. This has the result that the protruded region extending by distances ε₃, ε₄ from the boundary 12 is greater than the contact area 8. The required minimum protrusion is indicated by the shaded area.

In FIGS. 5B-7B, in each case, the results of the second step of the adaptation is shown. In the first case shown in FIG. 5B, a distance d is set over the entire contact area between the deformed dental prosthetic item 5″ and the neighboring tooth 3, so that a gap 6′ is present.

In the second case shown in FIG. 6B, the surface of the neighboring tooth 3 and the surface of the deformed dental prosthetic item 5″ abut each other exactly without any gap therebetween.

In the third case shown in FIG. 7B, a protrusion of width d is established between the deformed dental prosthetic item 5″ and the neighboring tooth 3. The arrows indicate how the surface of the prosthetic item 5′, represented by the dashed line, changes after the first step.

Each of FIGS. 5C-7C represents the situation after the third step. Near the boundary 12 of the contact area 15 of the dental prosthetic item 5″ the surface of the dental prosthetic item 5″ is smoothed so as to give a smooth transition between the contact area 15 and the surrounding surface 16 on the dental prosthetic item 5″.

In the third case, shown in FIG. 7C, this has the result that the contact area 15 on the dental prosthetic item 5″ is larger than the selected contact area 8 on the neighboring tooth. It has been found, however, that it is of no great practical significance when the contact area is somewhat larger in this case.

1. A method for adapting a digital dental prosthetic item (5) existing in the form of a 3D data set produced on the basis of a 3D data set of a preparation zone (1), which preparation zone (1) comprises the actual preparation site (2) and also at least one neighboring tooth (3, 4), wherein for adaptation of the approximal contact between said dental prosthetic item (5) and said neighboring tooth (3) a contact area (8) is defined on said neighboring tooth (3) and that said dental prosthetic item (5) is automatically adapted to said contact area.

2. The method according to claim 1, wherein said contact area (8) is defined by selection of a point (9) on said neighboring tooth (3) and that variable parameters (B, L) for specifying the extent of said contact area (8) around said selected point (9) determine the size of said contact area (8).

3. The method according to claim 2, wherein said contact area (8) is in the form of an elliptical zone.

4. The method according to claim 1, wherein a parameter (d) for defining the distance of said deformed dental prosthetic item (7) from said neighboring tooth (3) in said contact area (8) is variable.

5. The method according to claim 4, wherein for adaptation of said dental prosthetic item (5) to fit said contact area (8), deformation of said dental prosthetic item (5) first takes place, the dental prosthetic item (5) being deformed toward the contact area (8), preferably towards its center point (9), until the deformed dental prosthetic item (5′) is at least at the required distance (d) from the neighboring tooth (3) at least along a boundary (12) of said contact area (8).

6. The method according to claim 5, wherein said dental prosthetic item (5′) is further deformed within said boundary (12) of said contact area (8) such that said deformed dental prosthetic item (7) is at the required distance (d) from said neighboring tooth (3) over the entire contact area (8).

7. The method according to claim 6, wherein the transition (14) between said contact area (15) of said dental prosthetic item (7) and the surrounding region (16) is smoothed.

8. The method according to claim 1, wherein said contact area (8) on said neighboring tooth (3) is obtained from a model of the neighboring tooth stored in a tooth database, in which case the model of the neighboring tooth has a pre-defined contact area.

9. The method according to claim 1, wherein said selected contact area (8) is indicated in an optically distinguishable manner.

10. The method according to claim 1, wherein said selected contact area (8) is modifiable, i.e., it can be moved along the surface of said neighboring tooth (3) and can be re-sized.

11. The method according to claim 1, wherein the contact area can be drawn in by the user.
